(19) United States
(12) Patent Application Publication
(10) Pub. No.: US 2026/0134353 A1
(43) Pub. Date: May 14, 2026

(54) HARDWARE GEOMETRIC REGULARIZATION

(71) Applicant: LUCIDITY SCIENCES, INCORPORATED, Wilmington, DE (US)

(72) Inventors: RICHARD W. WELLMAN, Salt Lake City, UT (US); ALEXANDRA V. PASI, South Jordan, UT (US); ALAN MULLENIX, South Jordan, UT (US)

(73) Assignee: LUCIDITY SCIENCES, INCORPORATED, Wilmington, DE (US)

(21) Appl. No.: 19/387,505

(22) Filed: Nov. 12, 2025

Related U.S. Application Data
(60) Provisional application No. 63/719,470, filed on Nov. 12, 2024.
(60) Provisional application No. 63/915,070, filed on Nov. 10, 2025.

(51) Int. Cl. G06N 20/10; G06F 17/11

(52) U.S. Cl. CPC G06N 20/10; G06F 17/11

(57) ABSTRACT

Apparatuses, systems, methods, and computer program products are disclosed for hardware geometric regularization. A method includes receiving training data comprising labeled data points. A method includes selecting a class of self-adjoint differential operator equations. A method includes selecting a set of orthogonal polynomials as a spectral basis. A method includes iteratively optimizing parameters of the differential operator equations based on the training data using a gradient-based optimizer to minimize an objective function. A method includes solving the optimized differential operator equation using a spectral method with the selected orthogonal polynomials to generate a reproducing kernel represented by a kernel tensor. A method includes outputting a machine learning model comprising the reproducing kernel combined with support vectors derived from the training data, the model configured to infer labels for unseen data points by estimating similarity measures using the reproducing kernel.

### FIELD

This invention relates to geometric regularization and more particularly relates to hardware geometric regularization for machine learning.

### BACKGROUND

For machine learning with kernels the few currently available kernel functions are typically off the shelf and standard, regardless of the problem to which they are applied.

### SUMMARY

Apparatuses are presented for hardware geometric regularization. In one embodiment, an apparatus includes a processor and/or a memory. A memory, in some embodiments, stores executable code that, when executed by a processor, cause an apparatus to perform operations. An operation, in certain embodiments, includes receiving training data comprising labeled data points. In one embodiment, an operation includes selecting a class of self-adjoint differential operator equations. An operation, in some embodiments, includes selecting a set of orthogonal polynomials as a spectral basis. An operation, in a further embodiment, includes iteratively optimizing parameters of differential operator equations based on training data using a gradient-based optimizer to minimize an objective function. An operation, in one embodiment, includes solving an optimized differential operator equation using a spectral method with selected orthogonal polynomials to generate a reproducing kernel represented by a kernel tensor. In certain embodiments, an operation includes outputting a machine learning model comprising a reproducing kernel combined with support vectors derived from training data, where the model configured to infer labels for unseen data points by estimating similarity measures using the reproducing kernel. In certain embodiments support vectors and their labels are learned via the iterative optimization procedure.

Other apparatuses are presented for hardware geometric regularization. A cluster of graphics processing units (GPUs), in some embodiments, each comprise a plurality of streaming multiprocessors configured for matrix multiplication and general tensor reductions. A cluster of GPUs, in one embodiment, is configured to receive training data comprising labeled data points. In a further embodiment, a cluster of GPUs is configured to parallelize computation across the GPUs by assigning differential operator equations to separate GPUs. In certain embodiments, a cluster of GPUs is configured to construct orthogonal polynomials as a spectral basis. A cluster of GPUs, in one embodiment, is configured to iteratively optimize parameters of differential operator equations by computing gradients of an objective function. In some embodiments, a cluster of GPUs is configured to solve optimized equations using a spectral method to generate a reproducing kernel tensor. In certain embodiments the GPUs are configured to search for optimally placed support vectors and labels. A cluster of GPUs, in certain embodiments, is configured to combine outputs from the GPUs to form a machine learning model using a reproducing kernel for similarity-based label inference.

In one embodiment, an apparatus includes means for receiving training data comprising labeled data points. An apparatus, in some embodiments, includes means for selecting a class of self-adjoint differential operator equations and a set of orthogonal polynomials as a spectral basis. An apparatus, in some embodiments, includes means for configuring support vectors and their labels. An apparatus, in a further embodiment, includes means for iteratively optimizing parameters of selected equations based on training data to minimize an objective function by computing gradients. An apparatus, in one embodiment, includes means for solving optimized equations using a spectral method to generate a data-dependent reproducing kernel represented as a kernel tensor. In particular embodiments the apparatus constructs kernel machines from the learned kernel by selecting support vectors and their labels. In certain embodiments, an apparatus includes means for outputting a machine learning model using a reproducing kernel to estimate similarities for label inference on unseen data.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an apparatus for geometric regularization in machine learning;

FIG. 2 is a schematic flow chart diagram illustrating one embodiment of a method executed by the apparatus for geometric regularization in machine learning;

FIG. 3 is a schematic diagram illustrating one embodiment of a kernel tensor structure for geometric regularization in machine learning;

FIG. 4 is a schematic block diagram illustrating one embodiment of a GPU cluster system for geometric regularization in machine learning;

FIG. 5 is a schematic diagram illustrating one embodiment of a parallelization process in a GPU cluster for geometric regularization in machine learning;

FIG. 6 is a schematic flow chart diagram illustrating one embodiment of an optimization method in a GPU cluster for geometric regularization in machine learning;

FIG. 7 is a schematic block diagram illustrating one embodiment of an apparatus for geometric regularization in machine learning; and

FIG. 8 is a schematic diagram illustrating one embodiment of a manifold regularization structure for geometric regularization in machine learning.

### DETAILED DESCRIPTION

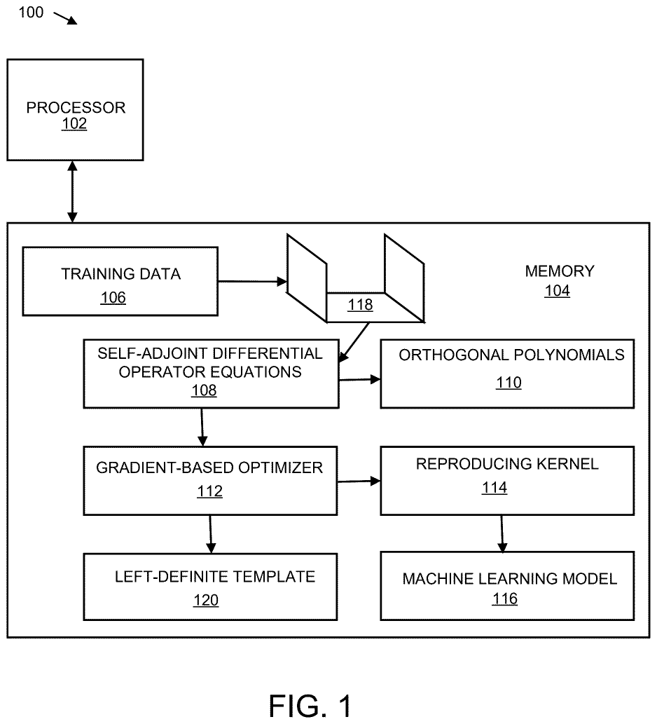

FIG. 1 depicts one embodiment of an apparatus 100 for geometric regularization in machine learning. In one embodiment, an apparatus 100 may comprise a processor 102 in communication with a memory 104. In some embodiments, a processor 102 may execute instructions stored in a memory 104 to process training data 106. In certain embodiments, a memory 104 may store code configured to enable receipt of training data 106 comprising labeled data points or the like.

In some embodiment, certain machine learning paradigms, such as kernel methods, may encounter significant limitations in scaling to large datasets. For example, some kernel methods rely on a limited set of canonical kernels with minor variations, which restricts their ability to adapt to diverse data contexts and/or leads to suboptimal performance on broad vector data applications. In certain embodiments, these methods demand substantial computational resources, often exhibiting cubic time complexity for training, which renders them infeasible for datasets exceeding millions of points without specialized hardware optimizations. In some embodiments, the interpretability of kernel-based models poses challenges, as implicit feature mappings obscure the understanding of decision processes, particularly in high-dimensional spaces.

Some use of kernel machines has been supplanted by deep learning due to the latter's handling of large-scale data and automatic feature extraction. Deep learning can excel in specific domains such as image processing and natural language, but it can lack the theoretical generalizability and elegance of kernel approaches for general vector data. The difficulties of dimensionality can affect kernel methods more acutely in isotropic covariate scenarios, whereas neural networks can mitigate this through hierarchical representations.

Some kernel methods struggle with selecting appropriate kernels, often requiring manual crafting that fails to capture data-specific geometries. In certain embodiments, numerical points close in Euclidean space may differ vastly in problem context, leading to poor similarity measures and inaccurate predictions. In certain embodiments, the inability to efficiently compute on central processing units exacerbates these issues for industrial applications involving vast labeled datasets.

In one embodiment, an apparatus 100 addresses these limitations by learning context-specific geometries encoded in reproducing kernels derived from self-adjoint differential operator equations. In some embodiments, an apparatus 100 may receive training data 106 comprising labeled vector data points within a d-dimensional unit cube ranging from −1 to 1 in each dimension and/or associated labels for supervised learning tasks such as classification and/or regression or the like. In certain embodiments, labeled data points in training data 106 may derive from processes generating vector data with real number labels, as described in embodiments involving hidden joint probability distributions on a data input space or the like.

In one embodiment, an apparatus 100 may embed input data into a d-dimensional unit cube 118. In some embodiments, embedding input data into a d-dimensional unit cube 118 may transform raw data to fit within intervals from −1 to 1 across multiple dimensions to facilitate polynomial expansions and/or kernel computations or the like. In certain embodiments, a d-dimensional unit cube 118 may serve as a data input space for modeling processes with multivariate polynomials defined thereon or the like. In some embodiments, this embedding may transform diverse data types to fit within −1 to 1 intervals, allowing multivariate polynomial models to infer labels via similarity measures.

In one embodiment, an apparatus 100 may select a class of self-adjoint differential operator equations 108 to model data generation processes. In some embodiments, a class of self-adjoint differential operator equations 108 may include separable partial differential operator equations defined by step function coefficients for derivatives of orders that are multiples of four and/or continuity self-adjoint boundary conditions or the like. In certain embodiments, self-adjoint differential operator equations 108 may comprise non-homogeneous equations in Hilbert function spaces containing multivariate polynomials as dense subsets, where operators map polynomials to polynomials and/or ensure unique kernel solutions or the like. In some embodiments, a class of self-adjoint differential operator equations 108 may factor into families of ordinary differential equations per dimension for independent solving in parallel environments or the like.

In one embodiment, such equations may incorporate continuity self-adjoint boundary conditions in discrete Sobolev spaces, enabling flexible decision surfaces without unnatural constraints typical in some other differential operators or the like. In some embodiments, continuity boundary conditions may enable flexibility in decision problems by avoiding unnatural constraints typical in standard differential operators, as in embodiments using GKN-EM theorems for self-adjoint extensions or the like. In certain embodiments, a discrete Sobolev space may support orthogonal polynomials that have theoretical properties extended to applied contexts, with boundary behaviors influencing solution precision or the like.

In one embodiment, an apparatus 100 may learn operators A and/or B that are unbounded and/or self-adjoint in Hilbert function spaces. In some embodiments, operators A and/or B may ensure invertibility and/or symmetry in kernel solutions, with non-homogeneous terms as kernels for bounded inverse operators or the like. In certain embodiments, tensor products of ordinary differential operators may restrict to orders multiples of four, starting from 4 up to 12 depending on Hilbert settings or the like.

In one embodiment, an apparatus 100 may select a set of orthogonal polynomials 110 as a spectral basis. In some embodiments, a set of orthogonal polynomials 110 may be chosen from classes comprising Chebyshev polynomials, ultraspherical polynomials, and/or Chebyshev-type discrete Sobolev polynomials or the like. In certain embodiments, orthogonal polynomials 110 may function as a spectral basis for solving differential operator equations via Galerkin methods, with choices influenced by Hilbert space settings and/or experimental considerations or the like. In some embodiments, a set of orthogonal polynomials 110 may be constructed recursively using fused multiply-add operations in single precision arithmetic to maintain numerical stability during computations or the like.

In one embodiment, an apparatus 100 may employ ultraspherical polynomials connected to Chebyshev types via formulas. In some embodiments, norms and/or connection coefficients may compute numerically exactly using gamma functions and/or binomial coefficients or the like. In certain embodiments, orthogonal polynomial sequences may equip Hilbert spaces with complete sets for spectral decompositions or the like.

In one embodiment, an apparatus 100 may precompute a left-definite template 120. In some embodiments, a left-definite template 120 may comprise a rank-4 data array formed from quadratures of derivatives of orthogonal polynomials over partition subintervals with scaling factors for balance in objective function gradients or the like. In certain embodiments, precomputing a left-definite template 120 may occur using high-precision arithmetic on a central processing unit before loading into a graphics processing unit for kernel tensor generation or the like. In some embodiments, a left-definite template 120 may associate with continuity boundary conditions in discrete Sobolev spaces and/or facilitate derivatives of spectral matrices as matrix slices or the like.

In one embodiment, an apparatus 100 may iteratively optimize parameters using a gradient-based optimizer 112 to minimize an objective function. In some embodiments, a gradient-based optimizer 112 in an iterative optimization may compute directional derivatives of an objective function selected from cross-entropy for classification and/or L2 loss for regression or the like. In certain embodiments, parameters in an optimizer 112 may include step function coefficients for differential operators and/or eigenvalues associated with orthogonal polynomials, with application of a gauge symmetry factor to scale parameters and/or maintain numerical precision within memory constraints or the like. In some embodiments, an iterative optimizer 112 may employ quasi-Newton methods, conjugated gradients, and/or trust region approaches in double precision to evaluate descent directions at each iteration or the like.

In one embodiment, an apparatus 100 overcomes scaling issues through parallel implementation on a cluster of graphics processing units, facilitating training on datasets of order 10\hat{ }7 points. In some embodiments, a processor 102 in communication with a memory 104 may execute code to factor separable partial differential operator equations into ordinary differential equations per dimension for independent solving. In certain embodiments, this factorization may assign computations across graphics processing units, achieving near-100% occupancy by prioritizing single-precision registers for orthogonal polynomial constructions and limiting double-precision usage to gradient computations or the like. In other embodiments kernel matrices are computed in single-precision so as to maximize data throughput to device memory.

In one embodiment, an apparatus 100 may incorporate a cluster of graphics processing units configured for parallel computation. In some embodiments, a cluster of graphics processing units may parallelize tasks by factoring separable self-adjoint partial differential operator equations into ordinary differential equations per data dimension and/or assigning each to separate graphics processing units or the like. In certain embodiments, graphics processing units in an apparatus 100 may construct orthogonal polynomials in single precision using recursive fused multiply-add operations synchronized across warps of 32 threads, achieving near-100% occupancy by prioritizing single-precision registers and/or limiting double-precision usage or the like.

In one embodiment, an apparatus 100 may select a number of orthogonal polynomials based on warp sizes of graphics processing units. In some embodiments, a number of orthogonal polynomials may limit to 32 in single precision for compatibility with graphics processing unit architecture, while in other embodiments doubling to 64 in double precision may enhance solution accuracy or the like. In certain embodiments, orthogonal polynomials may precompute in arbitrary precision for templates loaded into graphics processing units, allowing higher curvature in decision surfaces for separating data points or the like.

In one embodiment, an apparatus 100 may utilize commodity-level graphics processing units without tensor cores optimized for precise matrix operations. In some embodiments, such graphics processing units may favor double-precision registers over single-precision for calculations requiring high accuracy, contrasting with imprecise tensor core designs in standard artificial intelligence hardware or the like. In certain embodiments, an apparatus 100 may implement concessions in precision to accommodate existing graphics processing unit limitations, while in other embodiments custom hardware with all double-precision registers may improve continuity approximations or the like. In certain embodiments single-precision data pipelines are implemented to increase data throughput at the expense of double-precision accuracy.

In one embodiment, an apparatus 100 may solve an optimized differential operator equation using a spectral method to generate a reproducing kernel represented as a kernel tensor 114. In some embodiments, a kernel tensor 114 may be a rank-3 array where a reproducing kernel is a tensor product of dimensional kernels computed as quadratic forms with data expanded in orthogonal polynomials or the like. In certain embodiments, solving with a spectral method 114 may yield reproducing kernels as solutions to coupled non-homogeneous self-adjoint operator equations, ensuring symmetry, universality, and/or reproducibility in learned geometries or the like. In some embodiments, a kernel tensor 114 may derive from eigenvalue matrices and/or left-definite spectral matrices, with derivatives computed respecting spectral operator eigenvalues and/or differential operator step function values or the like.

In one embodiment, an apparatus 100 may learn dimensional kernels as quadratic forms with positive-definite symmetric matrices in kernel tensors. In some embodiments, kernel tensors may represent analytic expressions in terms of eigenvalues and/or differential operator parameters, avoiding numerical instabilities through gauge symmetries or the like. In certain embodiments, derivatives of kernel tensors may compute efficiently using matrix calculus for step function values and/or eigenvalues or the like.

In one embodiment, an apparatus 100 may compute spectral solutions using Galerkin methods with Chebyshev polynomials as standards for numerical solutions of partial differential equations. In some embodiments, Chebyshev-type discrete Sobolev orthogonal polynomials may serve in spectral bases for discrete spaces, influenced by heuristic and/or experimental factors or the like. In certain embodiments, multivariate polynomial models may depend analytically on governing partial differential operators, facilitating fits to training datasets via modified cross-entropy and/or L2 loss functionals or the like.

In one embodiment, an apparatus 100 may train with custom optimizers evaluating multiple descent directions per iteration. In some embodiments, objective descent directions may optimize linear approximations via gradient-based and/or quasi-Newton methods approximating objectives with quadratic models or the like. In certain embodiments, calculations of objective gradients may task individual graphics processing units with directional derivatives in heterogeneous computing environments or the like.

In one embodiment, an apparatus 100 may output a machine learning model 116 using a reproducing kernel combined with support vectors for similarity-based label inference. In some embodiments, a machine learning model 116 may infer labels for unseen data points by estimating similarity measures via a reproducing kernel, functioning as an adaptive neighbor model where basis functions measure proximity to support vectors or the like. In certain embodiments, support vectors in a machine learning model 116 may be derived from training data, with model basis polynomials generated via a reproducing kernel and/or support vectors to construct non-linear decision surfaces or the like.

In one embodiment, an apparatus 100 may output models as linear combinations of multivariate polynomials with support vectors. In some embodiments, basis polynomials may measure similarities between data points and/or support vectors, inducing kernel geometries on input spaces or the like. In certain embodiments, kernel tricks may map learning problems non-linearly into kernel Hilbert spaces solved linearly, with explicit feature maps defined via polynomial spectral bases or the like.

In one embodiment, an apparatus 100 solves the problem of limited kernels by iteratively optimizing parameters to generate data-dependent reproducing kernels represented as a kernel tensor 114. In some embodiments, a set of orthogonal polynomials 110, selected from classes including Chebyshev polynomials, ultraspherical polynomials, and/or Chebyshev-type discrete Sobolev polynomials, may serve as a spectral basis for Galerkin methods. In certain embodiments, these polynomials may construct recursively using fused multiply-add operations, maintaining precision in single-precision arithmetic while enabling high-curvature decision surfaces or the like.

In one embodiment, an apparatus 100 enhances interpretability and generalization by embedding input data into a d-dimensional unit cube 118 prior to processing. In some embodiments, support vectors derived from training data 106 may combine with the reproducing kernel to form an adaptive neighbor model, regularizing geometries for better fit to hidden joint probability distributions or the like.

In one embodiment, an apparatus 100 utilizes a left-definite template 120 precomputed in high-precision arithmetic to facilitate kernel tensor generation. In some embodiments, this template may load into graphics processing units, supporting derivatives of spectral matrices as matrix slices in optimization processes or the like.

In one embodiment, an apparatus 100 minimizes objective functions using a gradient-based optimizer 112 in an iterative process, addressing inefficiencies in certain other optimizations. In some embodiments, the optimizer may compute directional derivatives selected from cross-entropy for classification and/or L2 loss for regression, employing quasi-Newton methods in double precision.

In one embodiment, an apparatus 100 outputs a machine learning model 116 configured for similarity-based label inference on unseen data, surpassing certain other kernel limitations in broad applicability. In some embodiments, the model 116 may function as a kernel ridge regression machine, with explicit analytic dependence on governing differential operators. In certain embodiments, this approach may extend to manifold regularization as a special case, deforming ambient space kernels with graph Laplacians for semi-supervised learning on large datasets or the like.

In one embodiment, an apparatus 100 may deform an ambient space kernel for manifold regularization as a special case of a reproducing kernel. In some embodiments, manifold regularization may generalize theories involving graph Laplacians and/or semi-supervised learning on graphics processing units, extending to large datasets in industrial settings or the like. In certain embodiments, a reproducing kernel may encapsulate Riemannian geometries learned from data, akin to abstract generalizations of general relativity principles or the like.

In one embodiment, an apparatus 100 may integrate manifold assumptions motivating geometric regularizations. In some embodiments, extensions to manifold regularization may include kernel versions as special cases, training on large datasets viable in applied settings or the like. In certain embodiments, deformations of ambient space kernels may use graph Laplacians for semi-supervised learning, generalizing to Riemannian types or the like.

In one embodiment, an apparatus 100 may be configured for applications in pharmaceuticals, fintech, and/or particle physics data from CERN or the like. In some embodiments, data transformations via autoencoders may extend to various problem types beyond vector inputs or the like. In certain embodiments, simulated datasets may generate using learned models for explainability tools graphing kernel values or the like.

In one embodiment, an apparatus 100 may search through Hilbert geometries to induce regularized kernel geometries on data spaces. In some embodiments, feature maps may concretely define in terms of polynomial bases, learning kernel Hilbert spaces and/or inner-products explicitly or the like. In certain embodiments, positive step functions in Lagrangian symmetric coefficients may ensure self-adjointness in differential operators or the like.

In one embodiment, an apparatus 100 may factor multivariate operator equations into dimensional families in Hilbert spaces of functions on intervals. In some embodiments, tensor products of dimensional kernels may form model kernels for neighbor models or the like. In certain embodiments, empirical kernels may approximate via finite spectral expansions, ensuring reproducing properties in finite-dimensional subspaces or the like.

In one embodiment, an apparatus 100 may use Tychonov regularization schemes in reproducing kernel Hilbert scales. In some embodiments, minimizers may exist uniquely in Hilbert spaces, expanding in kernel sections over data points or the like. In certain embodiments, representer theorems may restrict optimizations to subspaces spanned by kernel evaluations at support vectors or the like.

In one embodiment, an apparatus 100 may pose operator equations in left-definite spaces with reproducing kernel solutions. In some embodiments, positivity conditions may verify via operator boundedness, recovering kernels as solutions to self-adjoint equations or the like. In certain embodiments, Hilbert scales may form continua of operator-induced kernel spaces for general learning settings or the like.

In one embodiment, an apparatus 100 may spectral decompose left-definite kernels for eigenseries expansions. In some embodiments, complete orthonormal sequences may arise from eigenfunctions, with reproducing kernels as sums over lambda-powered terms or the like. In certain embodiments, finite approximations may yield empirical kernels orthogonalizing under operator-regularized inner products or the like.

In one embodiment, an apparatus 100 may reformulate reproducing kernel theories in left-definite operator languages. In some embodiments, self-adjoint extensions may use GKN-EM theorems, with continuity as self-adjoint boundary conditions appropriate for learning problems or the like. In certain embodiments, differential operators in Lebesgue-Hilbert and/or discrete Sobolev spaces may tensor product for multidimensional data inputs or the like.

In one embodiment, an apparatus 100 may implement in CUDA C++ for graphics processing unit computations. In some embodiments, pseudo-code may summarize optimization algorithms, with subsystems for runtime and/or configuration or the like. In certain embodiments, active set methods and/or line searches may handle constraints in optimizations or the like.

In one embodiment, an apparatus 100 may test suites for polynomial expansions, templates, objectives, and/or optimizers. In some embodiments, identity tests may verify orthonormality in single and/or double precision or the like.

In one embodiment, an apparatus 100 may include means for receiving training data comprising labeled data points. In some embodiments, such means may parallelize solving across multiple dimensions in a massively parallel processing environment. In certain embodiments, means for selecting orthogonal polynomials may recursively construct Chebyshev-type discrete Sobolev polynomials.

In one embodiment, an apparatus 100 may integrate quantum computing extensions for solving high-dimensional equations beyond classical limits. In some embodiments, hybrid classical-quantum optimizers may minimize objectives over expansive parameter spaces using variational algorithms. In certain embodiments, such integrations may approximate spectral solutions in reproducing kernel Hilbert spaces with enhanced efficiency or the like.

In one embodiment, an apparatus 100 may adapt to federated learning for distributed training across devices while preserving data privacy. In some embodiments, secure aggregation protocols may protect sensitive information during parameter updates for differential operators. In certain embodiments, edge computing deployments may enable real-time inferences in resource-constrained environments using compact learned models or the like.

In one embodiment, an apparatus 100 may handle time-series data by incorporating temporal differential operators into the framework. In some embodiments, recurrent kernel structures may model sequential dependencies through evolving similarity measures. In certain embodiments, forecasting applications may predict future states based on historical support vectors with regularized geometries or the like.

In one embodiment, an apparatus 100 may incorporate blockchain for verifiable and decentralized training processes. In some embodiments, distributed ledgers may record optimization steps and kernel parameter evolutions. In certain embodiments, smart contracts may automate inference queries using validated reproducing kernels or the like.

In one embodiment, an apparatus 100 may support multimodal data fusion, combining vector inputs with images and/or text modalities. In some embodiments, cross-modal kernels may compute similarities across heterogeneous data types within unified unit cubes. In certain embodiments, projection layers may embed diverse inputs for cohesive processing and label inference or the like.

In one embodiment, an apparatus 100 may employ meta-learning strategies for rapid adaptation to novel tasks with few examples. In some embodiments, outer optimization loops may search over classes of differential equations for efficient few-shot learning. In certain embodiments, inner loops may fine-tune eigenvalues and step functions on task-specific training data 106 or the like.

In one embodiment, an apparatus 100 may utilize neuromorphic hardware for energy-efficient implementations of spectral methods. In some embodiments, spiking networks may approximate polynomial recursions in analog computing domains. In certain embodiments, memristor-based storage may hold kernel tensors with variable precision levels or the like.

In one embodiment, an apparatus 100 may extend to graph-structured data using operators defined on manifolds. In some embodiments, spectral graph convolutions may integrate with reproducing kernels for tasks like node classification. In certain embodiments, message-passing mechanisms may propagate similarities through support vector neighborhoods or the like.

In one embodiment, an apparatus 100 may incorporate Bayesian uncertainty quantification over operator parameters. In some embodiments, priors on step functions and eigenvalues may yield posterior distributions for kernels. In certain embodiments, sampling techniques may estimate inference variances, enhancing robustness in uncertain environments or the like.

In one embodiment, an apparatus 100 may optimize for adversarial robustness by including penalty terms in objectives. In some embodiments, regularizations may constrain kernel sensitivities to input perturbations within unit cubes. In certain embodiments, certification methods may bound label changes, providing guarantees absent in certain other kernel approaches, or the like.

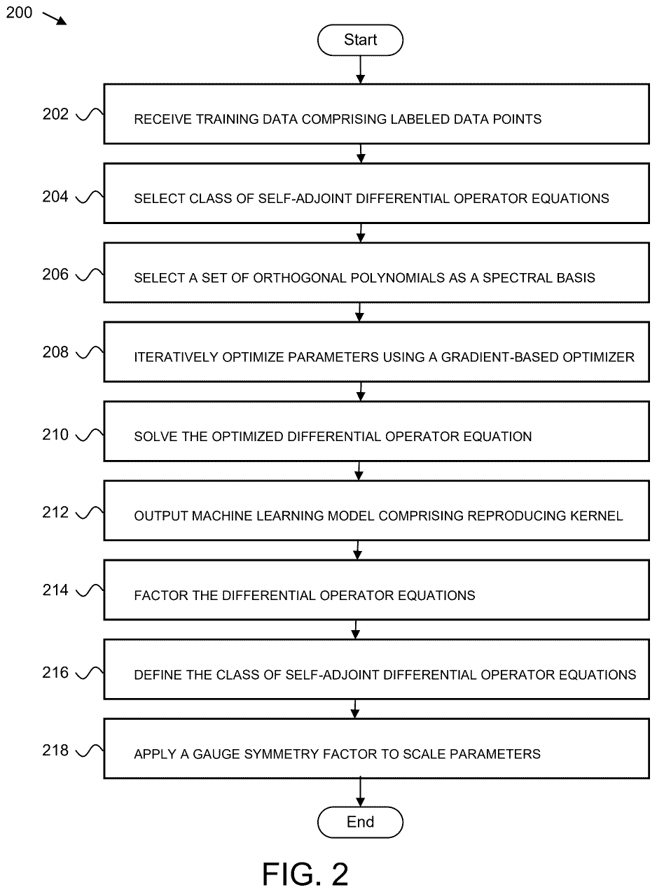

FIG. 2 depicts one embodiment of a method 200 for geometric regularization in machine learning. A method 200 begins and, in one embodiment, an apparatus 100 receives 202 training data 106 comprising labeled data points, where labeled data points refer to vector inputs paired with corresponding outputs such as binary labels for classification tasks or real-valued labels for regression tasks. In some embodiments, training data 106 may originate from a hidden joint probability distribution over a d-dimensional input space and label space, enabling an apparatus 100 to model underlying data generation processes, e.g., in pharmaceutical datasets where vectors represent molecular features and labels indicate efficacy scores or the like. In certain embodiments, receiving 202 training data 106 may involve loading datasets on the order of 10\hat{ }7 points into a memory 104, supporting supervised learning paradigms including multiclass classification where labels denote categories such as disease types or the like.

In one embodiment, an apparatus 100 embeds 202 input data into a d-dimensional unit cube 118 in response to receiving training data 106, with a d-dimensional unit cube 118 defined as the tensor product of intervals [−1, 1] across d dimensions to standardize data ranges. In some embodiments, embedding into a d-dimensional unit cube 118 may apply linear transformations to scale and shift original data values, ensuring compatibility with orthogonal polynomial bases that are naturally defined on [−1, 1], e.g., transforming sensor readings from arbitrary ranges to this cube for consistent kernel computations or the like. In certain embodiments, a d-dimensional unit cube 118 may facilitate the application of multivariate polynomials as models, where high-dimensional data such as genomic sequences with dozens of features are projected into this space to mitigate numerical instabilities during spectral expansions or the like.

In one embodiment, an apparatus 100 selects 204 a class of self-adjoint differential operator equations 108 subsequent to data embedding, where self-adjoint differential operator equations 108 denote operators equal to their adjoints in a Hilbert space, guaranteeing real eigenvalues and symmetric kernel solutions. In some embodiments, a class of self-adjoint differential operator equations 108 may encompass separable partial differential equations characterized by step function coefficients 216 for derivatives of orders that are multiples of four, such as order 4, 8, or 12, and continuity self-adjoint boundary conditions that impose smoothness at endpoints without unnatural constraints. In certain embodiments, self-adjoint differential operator equations 108 may factor 214 into ordinary differential equations per dimension, e.g., decomposing a multidimensional problem into independent one-dimensional equations solvable in parallel, as in embodiments processing financial time-series data across multiple variables or the like. In some embodiments, step function coefficients 216 with continuity self-adjoint boundary conditions may ensure operator invertibility, allowing unique solutions via GKN-EM theorems, where continuity conditions permit flexible learning of decision boundaries unlike periodic or Dirichlet conditions in traditional PDEs or the like.

In one embodiment, an apparatus 100 selects 206 a set of orthogonal polynomials 110 as a spectral basis following selection of differential operator equations, with orthogonal polynomials 110 defined as sequences of polynomials that are mutually orthogonal with respect to an inner product in a Hilbert space, forming a complete basis for function approximations. In some embodiments, a set of orthogonal polynomials 110 may comprise Chebyshev polynomials of the first kind, which satisfy orthogonality with weight (1−x\hat{ }2)\hat{ }−{1/2} on [−1, 1], ultraspherical polynomials generalizing Legendre and Chebyshev types, and/or Chebyshev-type discrete Sobolev polynomials incorporating discrete norms for boundary emphasis. In certain embodiments, orthogonal polynomials 110 may construct recursively via three-term recurrence relations using fused multiply-add operations, e.g., computing coefficients with formulas involving gamma functions for exact norms, supporting spectral methods in discrete Sobolev spaces or the like. In some embodiments, selecting 206 orthogonal polynomials 110 may depend on Hilbert space norms, e.g., choosing ultraspherical for continuous problems or discrete Sobolev for data with boundary sensitivities, as in particle physics simulations where precise endpoint continuity enhances model accuracy or the like.

In one embodiment, an apparatus 100 precomputes 206 a left-definite template 120 in conjunction with polynomial selection, where a left-definite template 120 constitutes a precalculated structure encoding integrals of polynomial derivatives over subintervals for efficient matrix assembly. In some embodiments, a left-definite template 120 may form a rank-4 data array from quadratures computed in arbitrary precision, incorporating scaling factors to balance contributions in objective function gradients during training. In certain embodiments, precomputing a left-definite template 120 may occur on a central processing unit using libraries like mpmath for high-precision arithmetic, subsequently loading the template into graphics processing units to accelerate kernel tensor derivatives as matrix slices or the like.

In one embodiment, an apparatus 100 iteratively optimizes 208 parameters using a gradient-based optimizer 112 to minimize an objective function after basis selection, with iterative optimization 208 involving repeated updates to parameters via descent directions computed from gradients. In some embodiments, a gradient-based optimizer in iterative optimization 208 may evaluate objectives such as modified cross-entropy for classification problems, where entropy measures prediction uncertainty against true labels, or L2 loss for regression, quantifying squared differences between predicted and actual values. In certain embodiments, a gauge symmetry factor 218 may apply during optimization to multiplicatively scale eigenvalues or step functions, preventing numerical overflow in matrix computations and maintaining stability within floating-point precision limits, e.g., adjusting scales dynamically based on parameter magnitudes or the like. In some embodiments, iterative optimization 208 may incorporate quasi-Newton approximations like L-BFGS for Hessian estimation, conjugated gradients for efficient search directions, and/or trust region methods to constrain step sizes, as in embodiments optimizing over hundreds of step function heights for complex datasets or the like.

In one embodiment, an apparatus 100 solves 210 an optimized differential operator equation using a spectral method to generate a reproducing kernel represented as a kernel tensor 114, where a spectral method approximates solutions by expanding in a basis of eigenfunctions or polynomials, projecting equations onto finite subspaces. In some embodiments, a kernel tensor 114 may assemble as a rank-3 array k=[k_n], with each k_n a positive-definite matrix enabling quadratic form computations for dimensional kernels κ_n(x, y)=[φ_i(x)]\hat{ }T k_n [φ_j(y)], where φ denote orthogonal polynomials. In certain embodiments, spectral solutions 210 may employ Galerkin projections to solve non-homogeneous self-adjoint equations BAκ(·, y)=α(x, y), yielding reproducing kernels that evaluate functions via inner products, e.g., ensuring κ(x, y)=κ(y, x) for symmetry in similarity measures or the like. In some embodiments, generating a kernel tensor 114 may involve eigenvalue decompositions of left-definite matrices, supporting universal approximation properties for arbitrary continuous functions on compact sets or the like.

In one embodiment, an apparatus 100 outputs 212 a machine learning model 116 using a reproducing kernel combined with support vectors for similarity-based label inference, with support vectors defined as selected data points v_i from training data 106 that influence the model's decision boundaries. In some embodiments, a machine learning model 116 may construct as a linear combination of basis polynomials p_i(x)=κ(x, v_i), inferring labels as weighted averages where weights derive from optimization, functioning as an adaptive neighbor model regularized by learned geometries. In certain embodiments, similarity-based label inference in a machine learning model 116 may compute proximities in kernel-induced spaces, e.g., classifying new points based on majority votes from nearest support vectors in pharmaceutical applications predicting drug interactions or the like.

In one embodiment, an apparatus 100 parallelizes operations across a cluster of graphics processing units during optimization 208, where parallelization distributes computational tasks to leverage massive thread counts for matrix operations. In some embodiments, graphics processing units may assign factored ordinary differential equations independently per dimension, synchronizing threads in warps of 32 for recursive polynomial constructions while achieving near-100% occupancy through efficient register allocation. In certain embodiments, commodity-level graphics processing units without tensor cores may prioritize precise floating-point arithmetic over approximate operations, e.g., using double precision for gradient evaluations in heterogeneous environments or the like.

In one embodiment, an apparatus 100 applies continuity self-adjoint boundary conditions 216 in discrete Sobolev spaces within differential operator selection 204, with discrete Sobolev spaces incorporating norms that penalize jumps at discrete points for smoothness. In some embodiments, such conditions may derive from GKN-EM theorems, constructing self-adjoint extensions that impose continuity at endpoints, differing from periodic conditions by allowing natural function behaviors suitable for learning tasks. In certain embodiments, boundary behaviors may guide polynomial selections, extending abstract orthogonal polynomial theories to practical implementations, e.g., in fintech models where continuity ensures stable predictions across market discontinuities or the like.

In one embodiment, an apparatus 100 selects a number of orthogonal polynomials 206 based on graphics processing unit warp sizes, where warp sizes refer to groups of threads executing in lockstep, typically 32 in NVIDIA architectures. In some embodiments, limiting the number to 32 polynomials in single precision may optimize for hardware synchronization, while expanding to 64 in double precision could improve approximation accuracy by including higher-degree terms. In certain embodiments, precomputed templates in arbitrary precision may incorporate more polynomials for finer resolutions, enabling models to capture intricate data curvatures in applications like CERN particle tracking or the like.

In one embodiment, an apparatus 100 learns operators A and/or B unbounded and self-adjoint in Hilbert spaces during optimization 208, with unbounded operators defined on dense domains in infinite-dimensional spaces, essential for differential equations. In some embodiments, operators A and/or B may guarantee kernel invertibility through positive-definiteness, with non-homogeneous terms α serving as kernels for A\hat{ }{−1}, ensuring bounded inverses. In certain embodiments, tensor products of ordinary differential operators Bn may vary orders from 4 to 12, adapting to Hilbert space norms for different regularization strengths, e.g., higher orders for smoother kernels in image-related extensions or the like.

In one embodiment, an apparatus 100 computes spectral solutions 210 with Galerkin methods using Chebyshev polynomials, where Galerkin methods project equations onto subspaces spanned by basis functions for approximate solutions. In some embodiments, Chebyshev-type discrete Sobolev orthogonal polynomials may incorporate discrete measures at boundaries, influenced by heuristic choices like norm weights for stability. In certain embodiments, multivariate polynomial models may exhibit explicit analytic dependence on partial differential operators, facilitating gradient computations for loss functionals like modified cross-entropy in classification scenarios or the like.

In one embodiment, an apparatus 100 trains with custom optimizers evaluating multiple descent directions per iteration 208, where descent directions indicate parameter updates reducing objective values. In some embodiments, objective descent directions may arise from linear approximations solved via gradient-based methods or quadratic models in quasi-Newton approaches. In certain embodiments, calculations of objective gradients may distribute directional derivatives across graphics processing units, supporting large-scale training in heterogeneous setups, e.g., for pharma datasets with millions of compounds or the like.

In one embodiment, an apparatus 100 reformulates reproducing kernel theories in left-definite operator languages during generation 210, with left-definite operators shifting spectra to positivity for well-posed problems. In some embodiments, self-adjoint extensions may apply GKN-EM theorems, designating continuity as boundary conditions tailored for machine learning flexibility. In certain embodiments, differential operators in Lebesgue-Hilbert or discrete Sobolev spaces may form tensor products for handling multidimensional inputs, e.g., in vector data from sensors or the like.

In one embodiment, an apparatus 100 employs ultraspherical polynomials connected via formulas in selection 206, where ultraspherical polynomials generalize Chebyshev with parameter λ controlling weight functions. In some embodiments, norms and connection coefficients may compute exactly using gamma and binomial functions, aiding numerical stability. In certain embodiments, orthogonal polynomial sequences may provide complete orthonormal bases for spectral decompositions in function spaces or the like.

In one embodiment, an apparatus 100 outputs models 212 as linear combinations of multivariate polynomials with support vectors, where multivariate polynomials approximate functions via tensor products of univariate bases. In some embodiments, basis polynomials may quantify similarities, imposing kernel geometries on input spaces for regularized neighbor models. In certain embodiments, kernel tricks may nonlinearly map problems into Hilbert spaces for linear solving, with explicit feature maps via polynomial expansions, e.g., in fintech for fraud detection or the like.

In one embodiment, an apparatus 100 learns dimensional kernels as quadratic forms with positive-definite matrices in tensors 210, ensuring Mercer conditions for valid kernels. In some embodiments, kernel tensors may express analytically in terms of eigenvalues and operator parameters, mitigating instabilities through gauge symmetries. In certain embodiments, derivatives of kernel tensors may employ matrix calculus for efficient step function and eigenvalue adjustments or the like.

In one embodiment, an apparatus 100 integrates manifold assumptions in regularization during solving 210, where manifold assumptions posit data lying on low-dimensional submanifolds in high-dimensional spaces. In some embodiments, extensions to manifold regularization may encompass kernel variants as special cases, suitable for large-scale training in industrial contexts. In certain embodiments, ambient space kernel deformations may incorporate graph Laplacians for semi-supervised learning, generalizing to Riemannian geometries, e.g., in biological data analysis or the like.

In one embodiment, an apparatus 100 configures for applications in various fields during output 212, such as pharmaceuticals for drug discovery or fintech for risk assessment. In some embodiments, data transformations via autoencoders may broaden applicability beyond vector inputs, e.g., to image or text modalities. In certain embodiments, simulated datasets generated from learned models may aid explainability tools by visualizing kernel values as graphs or heatmaps or the like.

In one embodiment, an apparatus 100 searches Hilbert geometries to induce regularized kernel geometries on data spaces in optimization 208. In some embodiments, feature maps may define concretely through polynomial bases, explicitly learning kernel Hilbert spaces and inner products. In certain embodiments, positive step functions in symmetric Lagrangian coefficients may preserve self-adjointness in operators or the like.

In one embodiment, an apparatus 100 factors multivariate operator equations into dimensional families in Hilbert spaces of interval functions during solving 210. In some embodiments, tensor products of dimensional kernels may constitute model kernels for neighbor-based predictions. In certain embodiments, empirical kernels approximated by finite spectral expansions may retain reproducing properties in subspaces or the like.

In one embodiment, an apparatus 100 uses Tychonov regularization schemes in reproducing kernel Hilbert scales during optimization 208, where Tychonov regularization adds penalty terms to stabilize ill-posed problems. In some embodiments, unique minimizers may exist in Hilbert spaces, expressible as expansions in kernel sections over data points. In certain embodiments, representer theorems may confine optimizations to finite-dimensional subspaces spanned by kernel evaluations at support vectors or the like.

In one embodiment, an apparatus 100 poses operator equations in left-definite spaces with reproducing kernel solutions 210, where left-definite spaces shift operator spectra positively. In some embodiments, positivity conditions may confirm through relative boundedness, retrieving kernels as equation solutions. In certain embodiments, Hilbert scales may create continua of operator-generated kernel spaces for diverse learning scenarios or the like.

In one embodiment, an apparatus 100 spectral decomposes left-definite kernels for eigenseries expansions in generation 210. In some embodiments, complete orthonormal sequences may derive from eigenfunctions, representing kernels as sums over powered eigenvalue terms. In certain embodiments, finite approximations may produce empirical kernels orthogonal under regularized inner products or the like.

In one embodiment, an apparatus 100 implements in CUDA C++ for graphics processing unit computations during execution. In some embodiments, pseudo-code may outline optimization algorithms, incorporating runtime and configuration subsystems. In certain embodiments, active set methods and line searches may manage constraints in optimizations or the like.

In one embodiment, an apparatus 100 tests suites for polynomial expansions, templates, objectives, and optimizers in validation phases. In some embodiments, identity tests may confirm orthonormality in single and/or double precision arithmetic or the like.

In one embodiment, an apparatus 100 includes means for receiving data in operational flows. In some embodiments, such means may parallelize solving across massively parallel environments. In certain embodiments, means for selecting orthogonal polynomials may recursively construct Chebyshev-type discrete Sobolev polynomials or the like.

In one embodiment, an apparatus 100 integrates quantum computing extensions for high-dimensional equation solving. In some embodiments, hybrid classical-quantum optimizers may minimize objectives over extensive parameter spaces using variational algorithms. In certain embodiments, such integrations may approximate spectral solutions in reproducing kernel Hilbert spaces with improved efficiency or the like.

In one embodiment, an apparatus 100 adapts to federated learning for distributed training while safeguarding data privacy. In some embodiments, secure aggregation protocols may shield sensitive details during differential operator parameter updates. In certain embodiments, edge computing implementations may support real-time inferences in limited-resource settings using streamlined learned models or the like.

In one embodiment, an apparatus 100 handles time-series data by integrating temporal differential operators into the framework. In some embodiments, recurrent kernel structures may capture sequential dependencies via evolving similarity measures. In certain embodiments, forecasting models may project future states relying on historical support vectors with tailored geometries or the like.

In one embodiment, an apparatus 100 incorporates blockchain for verifiable decentralized training procedures. In some embodiments, distributed ledgers may log optimization iterations and kernel parameter progressions. In certain embodiments, smart contracts may facilitate automated inference requests employing authenticated reproducing kernels or the like.

In one embodiment, an apparatus 100 supports multimodal data fusion, merging vector inputs with images and/or text. In some embodiments, cross-modal kernels may assess similarities across varied data forms within consolidated unit cubes. In certain embodiments, projection layers may map diverse inputs for unified processing and label prediction or the like.

In one embodiment, an apparatus 100 employs meta-learning approaches for swift adaptation to new tasks with minimal examples. In some embodiments, outer optimization loops may explore classes of differential equations for effective few-shot learning. In certain embodiments, inner loops may refine eigenvalues and step functions on specific task training data 106 or the like.

In one embodiment, an apparatus 100 utilizes neuromorphic hardware for energy-efficient spectral method executions. In some embodiments, spiking neural networks may simulate polynomial recursions in analog domains. In certain embodiments, memristor arrays may store kernel tensors with adjustable precision or the like.

In one embodiment, an apparatus 100 extends to graph-structured data employing manifold-defined operators. In some embodiments, spectral graph convolutions may merge with reproducing kernels for node classification tasks. In certain embodiments, message-passing systems may disseminate similarities via support vector networks or the like.

In one embodiment, an apparatus 100 incorporates Bayesian uncertainty quantification across operator parameters. In some embodiments, priors on step functions and eigenvalues may yield posterior distributions for kernels, enabling probabilistic modeling. In certain embodiments, sampling methods may compute inference variances, bolstering robustness in uncertain contexts or the like.

In one embodiment, an apparatus 100 optimizes for adversarial robustness by integrating penalty terms in objectives. In some embodiments, regularizations may limit kernel sensitivities to perturbations within unit cubes. In certain embodiments, certification techniques may constrain label variations, offering assurances not present in conventional kernel methods or the like.

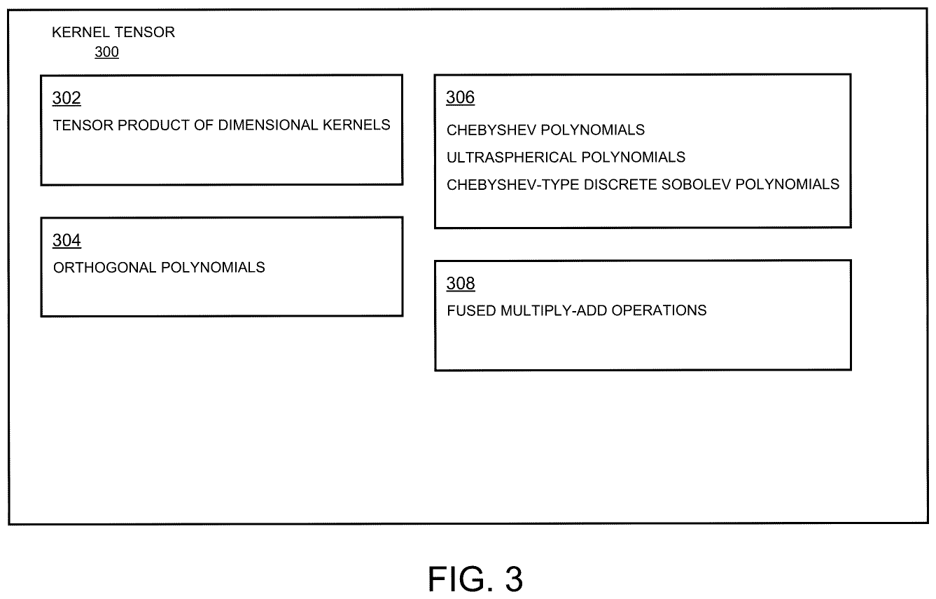

FIG. 3 depicts one embodiment of a kernel tensor structure 300 for geometric regularization in machine learning. In one embodiment, a kernel tensor structure 300 may represent a rank-3 array k=[k_d] where each k_d denotes a positive-definite symmetric matrix facilitating dimensional kernel computations. In some embodiments, a kernel tensor structure 300 may derive from eigenvalue matrices and left-definite spectral matrices, enabling analytic expressions in terms of spectral operator eigenvalues and differential operator parameters or the like. In certain embodiments, elements of a kernel tensor structure 300 may compute as k_d=exp(γ_d)*[(λ_{d, i} λ_{d, j})\hat{ }{−1}]⊙[<B_d φ_i, φ_j>H]\hat{ }{−1}, where γ_d acts as a gauge parameter, λ{d, i} are eigenvalues, B_d are differential operators, and φ_i are orthogonal polynomials, supporting numerical stability in high-dimensional data processing or the like.

In one embodiment, a tensor product of dimensional kernels 302 may form a reproducing kernel κ=⊗_{d=1}\hat{ }D κ_d, computed as quadratic forms with data expanded in orthogonal polynomials 304. In some embodiments, quadratic forms with data expanded in orthogonal polynomials 304 may express κ_d(x, y)=[φ_i(x)]\hat{ }T k_d [φ_j(y)], where φ_i(x) denotes expansions Φ(x)=[φ_i(x)]_i=1\hat{ }S in a spectral basis of S polynomials, allowing efficient evaluation via matrix multiplications. In certain embodiments, such quadratic forms 304 may leverage the kernel trick to map data nonlinearly into feature spaces, e.g., transforming vector inputs in pharmaceutical datasets to measure molecular similarities without explicit high-dimensional computations or the like.

In one embodiment, representations of specific orthogonal polynomials 306 may include Chebyshev polynomials T_n(x) defined by the recurrence T_0(x)=1, T_1(x)=x, T_n(x)=2x T_{n−1}(x)−T_{n−2}(x) for n≥2, orthogonal with respect to the weight (1−x\hat{ }2)\hat{ }{−1/2} on [−1, 1]. In some embodiments, Chebyshev polynomials 306 may serve as a basis for Gaussian quadrature rules, with zeros x_{n, i}=cos((2i−1)π/(2n)) providing exact integration for polynomials of degree less than 2n−1, e.g., approximating integrals in left-definite template constructions or the like. In certain embodiments, trigonometric definitions T_n(x)=cos(n arccos(x)) for Chebyshev polynomials 306 may enable exact evaluations at endpoints, supporting boundary condition implementations in discrete spaces or the like.

In one embodiment, representations of ultraspherical polynomials 306, denoted P\hat{ }{(α)}_n(x) for α≥0, may generalize Chebyshev polynomials with the Jacobi recurrence P\hat{ }{(α)}_0(x)=1, P\hat{ }{(α)}_1(x)=2αx/(α+1), and subsequent terms via coefficients a_n=2(n+α)(n+2α)/((n+1)(2α+n+1)), b_n=(n\hat{ }2+2αn)/((n+1)(2α+n+1)). In some embodiments, ultraspherical polynomials 306 may orthogonalize under the weight (1−x\hat{ }2)\hat{ }{α−1/2}, with norms ||P\hat{ }{(α)}_n||\hat{ }2=π2\hat{ }{1−2α}Γ(n+2α)/(Γ(α)\hat{ }2(n+α)Γ(n+1)), facilitating connection formulas for discrete variants or the like. In certain embodiments, derivatives of ultraspherical polynomials 306 may compute via relations like (d/dx) P\hat{ }{(α)}n(x)=n P\hat{ }{(α+1)}{n−1}(x)/(α+n), aiding quadrature evaluations over subintervals in tensor constructions, e.g., in financial modeling for volatility surfaces or the like.

In one embodiment, representations of Chebyshev-type discrete Sobolev polynomials 306 may incorporate discrete norms at boundaries, defined via connection formulas to ultraspherical polynomials as Q_k(x)=Σ{i=k−m−1}\hat{ }k c{k, i} P\hat{ }{(m+1)}i(x), with coefficients c{k, i} solving systems ensuring orthogonality under combined continuous and discrete measures. In some embodiments, Chebyshev-type discrete Sobolev polynomials 306 may satisfy discrete orthogonality Σ{j=0}\hat{ }m β_j [Q_k\hat{ }{(j)}(±1)] [Q_l\hat{ }{(j)}(±1)]+∫{−1}\hat{ }1 Q_k(x) Q_l(x) dω(x)=δ_{k, l}, where β_j are positive constants emphasizing boundary derivatives, suitable for problems with endpoint sensitivities. In certain embodiments, normalized versions \hat{ }Q_k(x)=Q_k(x)/||Q_k|| may yield connection coefficients \hat{ }c_{k, j}=c_{k, j}/||Q_k||, computed exactly using gamma functions and binomial coefficients for numerical precision in spectral approximations or the like.

In one embodiment, orthogonal polynomials may construct recursively using fused multiply-add operations 308, defined as hardware-accelerated instructions computing a*b+c in a single cycle to reduce rounding errors. In some embodiments, fused multiply-add operations 308 may implement three-term recurrences for Chebyshev polynomials, e.g., via CUDA intrinsics fmaf(a, b, c) in single precision, ensuring stability for up to degree 32 without significant loss of orthogonality. In certain embodiments, recursive constructions with fused multiply-add 308 may extend to ultraspherical polynomials, computing coefficients like a_n and b_n exactly before applying recurrences, e.g., in GPU kernels for parallel evaluation across data points or the like.

In one embodiment, a kernel tensor structure 300 may facilitate derivatives with respect to step function values b_{d, r, s} as ∂k_d/∂b_{d, r, s}=−exp(γ_d)*[(λ_{d, i} λ_{d, j})\hat{ }{−1}]⊙L_{r, s, i, j}\hat{ }{−1}, where L denotes a left-definite template slice. In some embodiments, such derivatives may support gradient-based optimization by enabling efficient matrix calculus in CUDA implementations. In certain embodiments, eigenvalue derivatives of a kernel tensor 300 may compute as ∂k_d/∂λ_{d, i}=exp(γ_d)*(e_i⊗1\hat{ }T+1⊗e_i\hat{ }T)⊙M_d\hat{ }{−1}/λ_{d, i}\hat{ }2, where e_i are standard basis vectors, aiding parameter adjustments in training or the like.

In one embodiment, quadratic forms 304 may embody the kernel trick, where inner products in high-dimensional feature spaces compute via kernels without explicit mappings. In some embodiments, expansions in orthogonal polynomials 304 may provide explicit feature maps Φ(x), contrasting implicit maps in standard kernels, e.g., enabling direct interpretations in Hilbert scales. In certain embodiments, tensor products 302 may ensure separability, reducing computational complexity from O(D S\hat{ }2) to O(D S\hat{ }2) with independent dimensional calculations or the like.

In one embodiment, orthogonal polynomials 306 may integrate with Bochner-Krall operators, differential operators with polynomial coefficients preserving orthogonality. In some embodiments, such integrations may approximate operator spectra asymptotically, enhancing theoretical justifications for basis choices. In certain embodiments, alternative bases like Legendre polynomials may substitute for ultraspherical 306 in uniform weight scenarios, offering flexibility in measure selections or the like.

In one embodiment, fused multiply-add operations 308 may optimize for NVIDIA architectures, leveraging streaming multiprocessors for parallel recursion. In some embodiments, these operations 308 may fuse in Cholesky factorizations for matrix inversions within kernel computations. In certain embodiments, extensions to higher-precision fused operations may support arbitrary-precision libraries like mpmath for template precomputations or the like.

In one embodiment, a kernel tensor 300 may extend to empirical kernels κ_n(x, y)=Φ_n(x)\hat{ }T (D+M)\hat{ }{−1}Φ_n(y), approximating infinite-dimensional kernels finitely. In some embodiments, such empirical forms may orthogonalize under operator-regularized inner products, ensuring positivity for valid Mercer kernels. In certain embodiments, spectral decompositions of kernels may yield eigenseries Σ_{j=1}\hat{ }∞λ_j\hat{ }{−r}φ_j(x)φ_j(y), with finite truncations for practical implementations or the like.

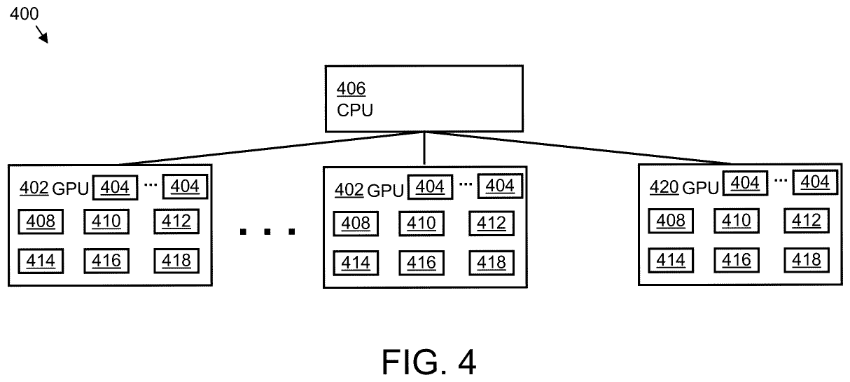

FIG. 4 depicts one embodiment of a GPU cluster system 400 for geometric regularization in machine learning. In one embodiment, a GPU cluster system 400 may constitute a heterogeneous computing environment comprising multiple interconnected graphics processing units designed for parallel execution of linear algebra tasks essential to training and inference. In some embodiments, a GPU cluster system 400 may scale to handle datasets exceeding 10\hat{ }7 labeled points by distributing workloads across devices 402, 420, minimizing host-device data transfers to avoid bottlenecks in PCIe bandwidth, typically limited to 16 GB/s per lane in Gen 4 interfaces. In certain embodiments, configurations of a GPU cluster system 400 may include NVIDIA A100 or V100 series cards linked via NVLink for high-speed peer-to-peer communication at up to 300 GB/s, enabling seamless aggregation of results from distributed computations or the like.

In one embodiment, multiple GPUs 402, 420 may each incorporate hundreds to thousands of cores organized into streaming multiprocessors 404, facilitating simultaneous execution of threads in warps for data-parallel operations. In some embodiments, multiple GPUs 402, 420 may number from 4 to 8 in a single node, expandable to clusters via infiniband networks at 200 Gb/s, supporting fault-tolerant designs with redundancy for uninterrupted training in cloud environments like AWS EC2 instances. In certain embodiments, multiple GPUs 402, 420 may operate without reliance on specialized AI accelerators, prioritizing general-purpose compute unified device architecture (CUDA) capabilities for custom kernel implementations or the like.

In one embodiment, streaming multiprocessors 404 for matrix multiplication may comprise tensor processing units within each GPU 402, 420, though in this system they may remain unused to favor precision over throughput. In some embodiments, streaming multiprocessors 404 may execute GEMM (general matrix multiply) operations in FP32 at rates exceeding 19.5 TFLOPS per SM in Ampere architecture, with dynamic partitioning of warps for mixed-precision workloads. In certain embodiments, streaming multiprocessors 404 may handle block-sparse matrix formats to optimize memory access patterns, reducing global memory loads through shared memory caching at 164 KB per SM or the like.

In one embodiment, interconnection via a central processing unit 406 for communication may employ multi-threading libraries like OpenMP or std::thread in C++ to orchestrate data distribution and synchronization. In some embodiments, a central processing unit 406 may utilize Intel Xeon or AMD EPYC processors with up to 128 cores, managing NVLink bridges for direct GPU-to-GPU transfers bypassing host memory. In certain embodiments, communication protocols in a central processing unit 406 may include MPI (Message Passing Interface) for distributed clusters, ensuring low-latency reductions of partial gradients across nodes in large-scale deployments or the like.

In one embodiment, parallelizing computation by assigning differential operator equations 408 to separate GPUs 402, 420 may distribute factored ordinary differential equations across devices, with each handling one or more dimensions based on load balancing. In some embodiments, assignment of differential operator equations 408 may use CUDA streams for asynchronous execution, overlapping kernel launches with data copies to hide latencies, e.g., processing 24-dimensional data by allocating equations 408 to 24 GPUs in a DGX station. In certain embodiments, such parallelization of differential operator equations 408 may achieve linear speedup, reducing training times from days on CPUs to hours, as in analyzing CERN collider data with high-dimensional event features, or the like.

In one embodiment, constructing orthogonal polynomials 410 may occur in parallel across GPU threads, leveraging shared memory for recurrence coefficients to minimize global accesses. In some embodiments, polynomial 410 construction may limit series to degree 32 aligned with warp sizes, using device-level functions for per-thread evaluations without divergence. In certain embodiments, implementations of polynomial 410 construction may employ CUDA cooperative groups for intra-warp synchronization, ensuring coherent updates in recursive loops or the like.

In one embodiment, optimizing parameters with gradient 412 computation may task each GPU with subsets of directional derivatives, aggregating via all-reduce operations. In some embodiments, gradient 412 computation may utilize cuBLAS for batched matrix inversions, handling up to thousands of small matrices per iteration with minimal overhead. In certain embodiments, distributed optimization may incorporate Horovod for ring-allreduce, scaling to hundreds of GPUs in supercomputing, or the like.

In one embodiment, solving equations to generate the reproducing kernel tensor 414 may execute spectral projections in parallel, with each GPU computing dimensional components before reduction. In some embodiments, tensor 414 generation may employ cuTENSOR for high-performance contractions, supporting FP64 for accuracy in eigenvalue solves. In certain embodiments, kernel tensor 414 outputs from solving may be stored in unified memory for seamless host access, facilitating hybrid CPU-GPU workflows or the like.

In one embodiment, combining outputs to form the machine learning model 416 may synchronize partial results via host orchestration, assembling the final multivariate polynomial representation. In some embodiments, output combination may use CUDA events for timing dependencies, ensuring all dimensional kernels complete before tensor product assembly. In certain embodiments, model 416 formation may include post-processing for quantization, compressing weights for deployment on edge devices or the like.

In one embodiment, near-100% occupancy with prioritized registers 418 may optimize thread block configurations to maximize active warps per streaming multiprocessor, typically achieving 64 warps in Volta architecture. In some embodiments, register 418 prioritization may allocate up to 255 registers per thread in FP32 mode, limiting double-precision to critical paths like Cholesky decompositions to stay under 5% of total computations. In certain embodiments, occupancy optimization of registers 418 may employ NVIDIA Nsight Compute profiling to tune kernel launches, balancing local memory usage for spill reduction in complex recursions or the like.

In one embodiment, commodity-level GPUs 420 without tensor cores may refer to consumer-grade cards that emphasize CUDA cores for general-purpose floating-point operations over mixed-precision matrix multiply-accumulate units. In some embodiments, such GPUs 420 may deliver 9.7 TFLOPS in FP 64 via software emulation, sufficient for precise gradient evaluations in small-batch regimes. In certain embodiments, commodity GPUs 420 may integrate with consumer motherboards supporting up to 4 cards via PCIe, offering cost-effective scaling, or the like.

In one embodiment, a GPU cluster system 400 may incorporate liquid cooling solutions to sustain prolonged training sessions at peak clocks, e.g., maintaining 1410 MHz base frequencies under load. In some embodiments, power management in a GPU cluster 400 may cap at 250W per card to optimize thermal design power, extending hardware longevity in data centers. In certain embodiments, fault detection mechanisms in a GPU cluster 400 may use ECC (error-correcting code) memory to recover from bit flips, ensuring reliability in mission-critical applications or the like.

In one embodiment, parallel assignment of equations 408 may extend to FPGA hybrids for custom acceleration of specific kernels like FFT-based convolutions. In some embodiments, communication via CPU 406 may leverage RDMA (remote direct memory access) over Ethernet for low-latency inter-node transfers in multi-rack setups. In certain embodiments, gradient 412 computations may adapt to asynchronous SGD variants, reducing synchronization overhead in loosely coupled clusters or the like.

In one embodiment, polynomial 410 constructions may utilize texture memory for read-only coefficient arrays, improving cache hit rates in repeated evaluations. In some embodiments, tensor 414 generation may incorporate batched LU decompositions via cuSolver, handling ill-conditioned matrices with pivoting. In certain embodiments, model 416 combination may support ensemble methods, averaging outputs from multiple cluster runs for variance reduction or the like.

In one embodiment, register 418 occupancy optimizations may dynamically adjust block sizes based on runtime profiling, targeting 95-100% theoretical limits. In some embodiments, commodity GPUs 420 may overclock via tools for boosted performance in non-production testing. In certain embodiments, cluster 40 expansions may integrate with Kubernetes for orchestrated deployments, automating resource allocation across heterogeneous hardware or the like.

In one embodiment, a GPU cluster system 400 may feature MIG (multi-instance GPU) partitioning to isolate workloads, e.g., dedicating instances to different optimization phases. In some embodiments, energy-efficient modes in GPUs 402 may throttle clocks during idle periods, conserving power in intermittent training schedules. In certain embodiments, diagnostic tools like DCGM (Data Center GPU Manager) may monitor health metrics, predicting failures in long-running jobs or the like.

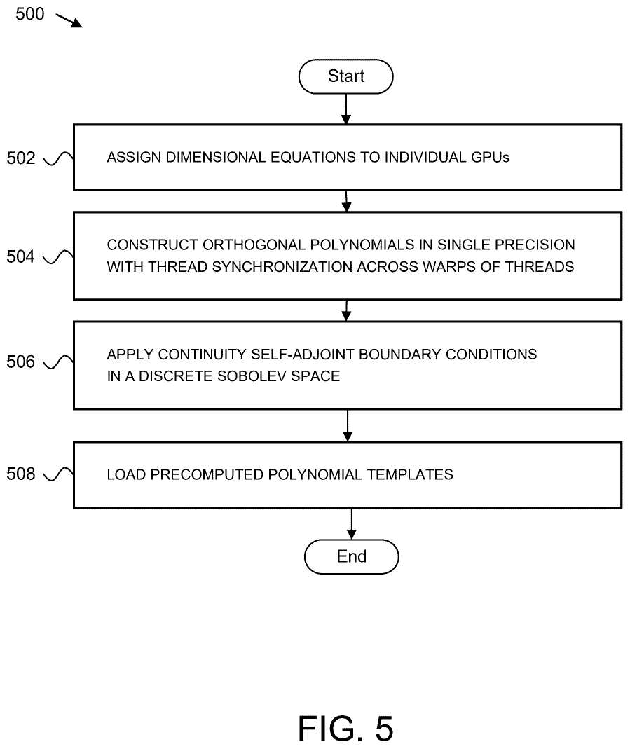

FIG. 5 depicts one embodiment of a method 500 for geometric regularization in machine learning. In one embodiment, an apparatus 100 assigns 502 dimensional equations to individual GPUs 402, where dimensional equations denote the factored ordinary differential components BnAnκn(·, y)=αn(x, y) for each data dimension n, enabling independent processing. In some embodiments, assignment 502 may employ load-balancing algorithms such as round-robin or dynamic scheduling based on GPU utilization metrics, e.g., distributing 48-dimensional problems across 8 GPUs by grouping 6 equations per device to optimize for memory bandwidth limitations of 900 GB/s in HBM2e memory. In certain embodiments, such assignment 502 may integrate with CUDA Multi-Process Service (MPS) to allow concurrent kernel executions from multiple processes, enhancing throughput in shared cluster environments like Slurm-managed high-performance computing nodes or the like.

In one embodiment, an apparatus 100 constructs 504 orthogonal polynomials 110 in single precision with thread synchronization across warps of 32 threads, where warps represent the fundamental scheduling units in GPU architectures executing instructions in SIMD (single instruction, multiple data) fashion. In some embodiments, thread synchronization 504 may utilize__syncwarp() intrinsics in CUDA to coordinate computations within warps, ensuring all 32 threads complete recurrence steps before proceeding, e.g., in evaluating three-term relations for up to degree 32 polynomials without branch divergence. In certain embodiments, single-precision construction 504 may leverage IEEE 754 FP32 format with 23-bit mantissas for approximately 7 decimal digits of accuracy, sufficient for initial polynomial generations while reserving double-precision FP64 for subsequent gradient-sensitive operations or the like.

In one embodiment, an apparatus 100 applies 506 continuity self-adjoint boundary conditions in a discrete Sobolev space, defined as conditions ensuring function and derivative continuity at endpoints through self-adjoint extensions derived from deficiency indices. In some embodiments, application 506 may incorporate Glazman-Krein-Naimark (GKN) theory to specify boundary forms like f, g=0 for continuity, contrasting with Dirichlet or Neumann conditions by allowing natural smoothness without over-constraining solutions. In certain embodiments, discrete Sobolev spaces in application 506 may use inner products combining L2 norms with finite-difference approximations at boundaries, e.g., enforcing orthogonality via sums over discrete masses Ni at ±1 for orders m up to 3, as in modeling physical systems with endpoint constraints like vibrational modes in molecular dynamics simulations or the like.

In one embodiment, an apparatus 100 loads 508 precomputed polynomial templates 120, where templates comprise multi-dimensional arrays storing quadrature weights and connection coefficients for rapid assembly of spectral matrices. In some embodiments, loading 508 may utilize cudaMemcpyAsync for asynchronous transfers from host to device memory, overlapping with computations to reduce effective latency, e.g., copying 4D tensors of size [m, S, P, P] where m is Sobolev order, S is polynomial degree, and P is partition count. In certain embodiments, precomputed templates 120 in loading 508 may generate offline using arbitrary-precision libraries like GMP on CPUs, ensuring error bounds below 10\hat{ }{−15} before compression to FP32 for GPU compatibility or the like.

In one embodiment, parallelization in an apparatus 100 may incorporate atomic operations for shared updates during assignment 502, preventing race conditions in multi-GPU reductions. In some embodiments, dimensional independence in assignment 502 may allow for heterogeneous GPU allocations, e.g., assigning compute-intensive high-order equations to A100 GPUs while routing lower-order ones to T4 inferencing cards. In certain embodiments, such strategies may integrate with RAPIDS for accelerated dataframes, streamlining input partitioning across dimensions or the like.

In one embodiment, warp-level primitives in construction 504 may extend to ballot_sync for voting on convergence in iterative solvers embedded within polynomial recursions. In some embodiments, synchronization across 32 threads 504 may align with SIMT (single instruction, multiple threads) execution, minimizing mask divergence in conditional branches for degree-dependent computations. In certain embodiments, alternative warp sizes like 64 in future architectures could double polynomial degrees without occupancy penalties or the like.

In one embodiment, boundary condition matrices in application 506 may pre-factor using cuSolver for LU decompositions, accelerating repeated solves in iterative optimizations. In some embodiments, discrete Sobolev norms 506 may weight boundary terms with coefficients β_j up to 10\hat{ }3 for emphasis on higher derivatives, tuning via hyperparameters for specific datasets. In certain embodiments, extensions to non-symmetric boundaries could adapt for asymmetric data distributions in applications like seismic imaging or the like.

In one embodiment, template loading 508 may employ pinned host memory for faster DMA transfers, achieving rates up to 25 GB/s in PCIe Gen5 setups. In some embodiments, compressed templates 508 may use ZFP lossless compression for FP32 data, reducing storage from gigabytes to megabytes in large-degree scenarios. In certain embodiments, on-demand loading 508 could fetch subsets via unified virtual addressing, supporting out-of-core processing for templates exceeding device memory capacities or the like.

In one embodiment, fault-tolerant parallelization may replicate critical assignments 502 across redundant GPUs, using checkpointing every 100 iterations to resume from failures. In some embodiments, energy profiling during construction 504 may throttle clocks to 80% for sustained operations, balancing performance with thermal limits in dense racks. In certain embodiments, integration with DALI for data augmentation pipelines could preprocess inputs dimension-wise before assignment or the like.

In one embodiment, advanced synchronization in construction 504 may leverage grid_sync for block-level coordination in multi-block kernels. In some embodiments, application 506 of conditions may vectorize boundary evaluations using SIMT lanes, processing 32 endpoints concurrently. In certain embodiments, template caching in loading 508 could utilize L2 persistence controls via cudaFuncSetAttribute for frequent accesses or the like.

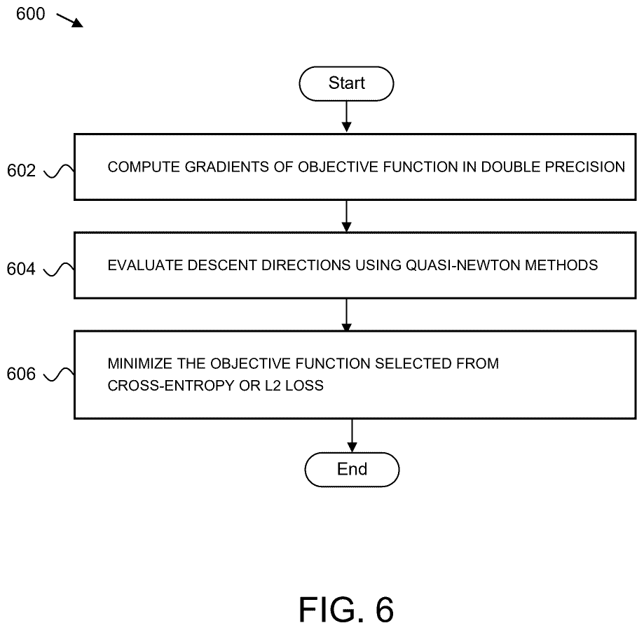

FIG. 6 depicts one embodiment of a method 600 for geometric regularization in machine learning. In one embodiment, an apparatus 100 computes 602 gradients of an objective function 112 in double precision, where double precision refers to IEEE 754 FP64 format providing approximately 15 decimal digits of accuracy to mitigate accumulation of rounding errors in derivative calculations. In some embodiments, gradient computation 602 may distribute directional derivatives across streaming multiprocessors 404 using cuBLAS routines like cublasDgemv for matrix-vector products, e.g., evaluating partials with respect to step function coefficients b_{d, r, s} as vectorized operations on kernel tensor slices. In certain embodiments, such computations 602 may handle design vectors of length exceeding 1000 by partitioning Jacobian approximations, ensuring scalability for multiclass problems with multiple spectral ridge machines or the like.

In one embodiment, an apparatus 100 evaluates 604 descent directions using quasi-Newton methods, defined as techniques that approximate the inverse Hessian matrix through low-rank updates based on secant conditions without direct second-derivative computations. In some embodiments, quasi-Newton evaluation 604 may apply BFGS updates as Hk+1=Hk−(Hk sk sk\hat{ }T Hk)/(sk\hat{ }T Hk sk)+(yk yk\hat{ }T)/(yk\hat{ }T sk), where sk=x_{k+1}−x_k and yk=∇φ(x_{k+1})−∇φ(x_k), initializing H0=(y0\hat{ }T y0)/(y0\hat{ }T s0) I for positive-definiteness. In certain embodiments, SR1 variants in evaluation 604 may use Hk+1=Hk+((yk−Hk sk)(yk−Hk sk)\hat{ }T)/((yk−Hk sk)\hat{ }T sk), conditioned on denominators exceeding 10\hat{ }{−8} norms to avoid skips, e.g., in optimizing pharmaceutical models where parameter spaces span ambient eigenvalues and differential coefficients or the like. In some embodiments, limited-memory L-BFGS in evaluation 604 may store only m=10-20 recent sk and yk pairs, recursing through two loops for step directions via vector operations in O(m n) time, where n denotes design vector dimension.

In one embodiment, an apparatus 100 minimizes 606 an objective function 112 selected from cross-entropy for classification or L2 loss for regression, where cross-entropy quantifies prediction-log-probability divergences as −Σy_i log(m_i(x_i)) for multiclass, and L2 loss sums squared residuals Σ(y_i−m(x_i))\hat{ }2 for continuous targets. In some embodiments, minimization 606 may enforce strong Wolfe conditions through line searches interpolating quadratics or cubics, e.g., finding steps α satisfying φ(x_k+αp_k)≤φ(x_k)+c1α∇φ(x_k)\hat{ }T p_k and |∇φ(x_k+αp_k)\hat{ }T p_k|≤c2|∇φ(x_k)\hat{ }T p_k| with c1=10\hat{ }{−4}, c2=0.9 for quasi-Newton directions. In certain embodiments, trust region frameworks in minimization 606 may solve subproblems argmin_{||p||≤Δ}∇φ(x_k)\hat{ }T p+(1/2) p\hat{ }T H_k p via Newton's method on secular equations s(λ)=1/Δ−1/||(H_k+λI)\hat{ }{−1} g||=0, safegaurding λ>max(0, −λ_min) with Cholesky trials or More-Sorensen lemmas for hard cases or the like.

In one embodiment, an apparatus 100 incorporates active set strategies during evaluation 604, estimating bound-constrained variables at zero and projecting quadratics onto working subspaces for feasible descents. In some embodiments, previous best step searches in minimization 606 may bracket intervals with β0=0, β1=α via cubic interpolants minimizing aα\hat{ }3+bα\hat{ }2+cα+d, computing coefficients from paired objective and gradient data. In certain embodiments, conjugated gradient updates in evaluation 604 may blend Fletcher-Reeves β_k\hat{ }{FR}=||∇φ(x_{k+1})||\hat{ }2/||∇φ(x_k)||\hat{ }2 with Polak-Ribiere β_k\hat{ }{PR}=∇φ(x_{k+1})\hat{ }T (∇φ(x_{k+1})−∇φ(x_k))/||∇φ(x_k)||\hat{ }2, clamping to ensure descent properties or the like.

In one embodiment, an apparatus 100 adapts L-BFGS-B variants for bound constraints in minimization 606, augmenting Lagrangians with active variables for dual solves post-Cauchy point identification. In some embodiments, gradient computations 602 may fuse with automatic differentiation libraries like PyTorch's autograd for symbolic partials, though custom CUDA kernels prioritize efficiency in tensor contractions. In certain embodiments, objective selections in minimization 606 may extend to Huber loss for robust regression, blending L2 and L1 behaviors via δ-thresholded formulations or the like.

In one embodiment, an apparatus 100 employs damped BFGS updates in evaluation 604 when curvature y_k\hat{ }T s_k≤0.2 s_k\hat{ }T H_k s_k, interpolating with θ_k=0.8 s_k\hat{ }T H_k s_k/(s_k\hat{ }T H_k s_k−y_k\hat{ }T s_k) to preserve positivity. In some embodiments, trust radius adjustments post-minimization 606 may ratio actual-to-predicted reductions ρ_k=(φ(x_k+p_k)−φ(x_k))/(p_k\hat{ }T ∇φ(x_k)+(1/2) p_k\hat{ }T H_k p_k), expanding Δ for ρ_k>0.75 or contracting for ρ_k<0.25. In certain embodiments, convergence checks in minimization 606 may monitor ||∇φ(x_k)||<10\hat{ }{−6} or relative changes |φ(x_k)−φ(x_{k−1})|/|φ(x_k)|<10\hat{ }{-4}, halting after 500 iterations in production runs or the like.

In one embodiment, an apparatus 100 integrates variance-reduced gradients in computation 602 for stochastic extensions, sampling mini-batches to approximate full-dataset derivatives. In some embodiments, quasi-Newton evaluations 604 may incorporate momentum terms akin to Adam, hybridizing with first-order methods for faster convergence in noisy landscapes. In certain embodiments, objective minimizations 606 may support elastic net penalties, combining L1 and L2 for sparse operator parameterizations in high-dimensional regimes or the like.

In one embodiment, an apparatus 100 utilizes proximal operators in minimization 606 for non-smooth objectives, handling L1-regularized variants via iterative soft-thresholding. In some embodiments, gradient computations 602 may offload to tensor processing units if available, though system design favors CUDA cores for FP64 dominance. In certain embodiments, descent direction evaluations 604 may explore Nesterov acceleration, lookahead steps p_k=−∇φ(x_k+μ(x_k−x_{k−1})) for momentum-enhanced quasi-Newton or the like.

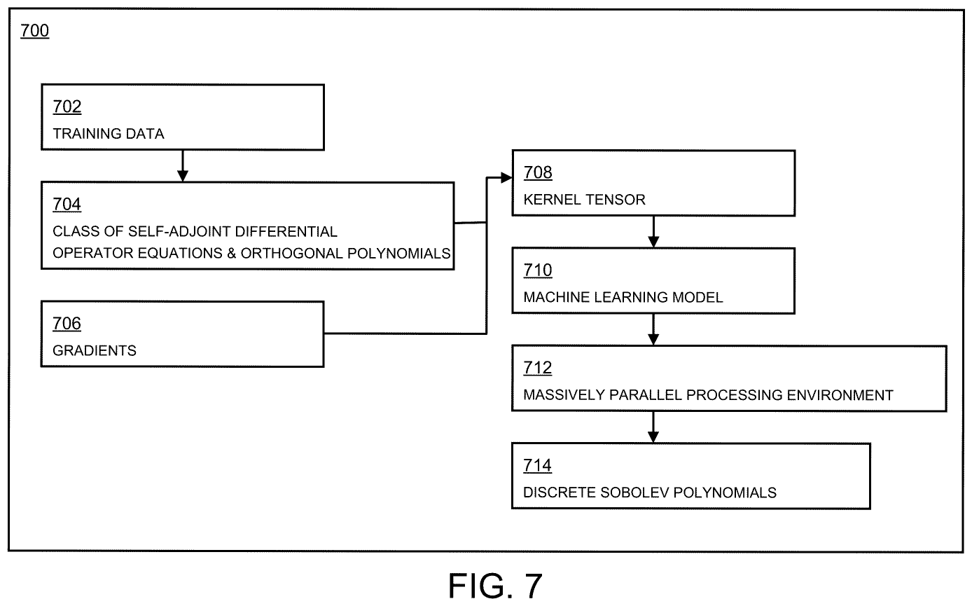

FIG. 7 depicts one embodiment of an apparatus 700 for geometric regularization in machine learning. In one embodiment, an apparatus 700 includes means 702 for receiving training data 106 comprising labeled data points, where such means may comprise input interfaces such as network adapters compliant with Ethernet standards at 100 Gbps or data ingestion pipelines utilizing Apache Kafka for streaming labeled vectors from distributed sources. In some embodiments, means 702 may incorporate buffer memories with capacities up to 128 GB DDR4 for temporary storage of incoming datasets, facilitating asynchronous reception to decouple data arrival from processing cycles. In certain embodiments, structural equivalents for means 702 may include serialized deserializers parsing JSON or Protocol Buffer formats, e.g., handling labeled pharmaceutical compounds with SMILES strings as vectors and binary efficacy labels or the like.

In one embodiment, an apparatus 700 includes means 704 for selecting a class of self-adjoint differential operator equations 108 and a set of orthogonal polynomials 110 as a spectral basis, where such means may comprise selector modules implemented as decision trees in software evaluating Hilbert space criteria like operator order and boundary type compatibility. In some embodiments, means 704 may utilize lookup tables stored in non-volatile flash memory to map problem characteristics, such as data dimensionality up to 100, to appropriate operator classes with step functions quantized to 16 levels per interval. In certain embodiments, structural equivalents for means 704 may involve heuristic engines applying rules-based selection, e.g., preferring order-8 operators for regression tasks in fintech datasets involving time-series features or the like.

In one embodiment, an apparatus 700 includes means 706 for iteratively optimizing parameters of selected equations based on training data 106 to minimize an objective function 112 by computing gradients, where such means may comprise optimization circuits or dedicated ASICs executing iterative loops with convergence tolerances of 10\hat{ }{−8}. In some embodiments, means 706 may integrate memory caches like L3 at 40 MB for storing intermediate Hessian approximations during quasi-Newton updates. In certain embodiments, structural equivalents for means 706 may feature distributed computing nodes synchronizing via MPI libraries, e.g., adjusting over 500 parameters in particle physics analyses from CERN data or the like.

In one embodiment, an apparatus 700 includes means 708 for solving optimized equations using a spectral method to generate a data-dependent reproducing kernel represented as a kernel tensor 114, where such means may comprise solver engines with pipelined arithmetic logic units for eigenvalue decompositions via Jacobi rotations. In some embodiments, means 708 may employ dedicated SRAM blocks of 512 KB for holding spectral matrices during Galerkin projections. In certain embodiments, structural equivalents for means 708 may involve FPGA-based accelerators programming Verilog modules for parallel QR factorizations, e.g., generating tensors for genomic sequence classifications or the like.

In one embodiment, an apparatus 700 includes means 710 for outputting a machine learning model 116 using a reproducing kernel to estimate similarities for label inference on unseen data, where such means may comprise output serializers formatting models as ONNX files for interoperability with inference engines. In some embodiments, means 710 may utilize high-speed USB 4.0 interfaces at 40 Gbps for transmitting compressed models to deployment servers. In certain embodiments, structural equivalents for means 710 may feature visualization modules rendering kernel similarity heatmaps via OpenGL shaders, e.g., exporting models for real-time predictions in autonomous systems or the like.

In one embodiment, an apparatus 700 includes means 712 for parallelizing solving means across multiple dimensions using a massively parallel processing environment, where such means may comprise interconnect fabrics like InfiniBand HDR at 200 Gbps linking up to 1024 processors for dimension-wise task distribution. In some embodiments, means 712 may incorporate job schedulers such as PBS Pro to allocate resources dynamically based on dimensional complexity. In certain embodiments, structural equivalents for means 712 may involve cluster management software like Bright Cluster Manager orchestrating workloads, e.g., parallelizing 64-dimensional solves in climate modeling applications or the like.

In one embodiment, an apparatus 700 includes means 714 for recursively constructing Chebyshev-type discrete Sobolev polynomials, where such means may comprise recursive loop processors with stack depths supporting degrees up to 128 via tail recursion optimizations. In some embodiments, means 714 may utilize vectorized SIMD instructions like AVX-512 for batch constructions across multiple instances. In certain embodiments, structural equivalents for means 714 may feature custom DSP chips executing Gram-Schmidt orthogonalizations, e.g., building polynomials for acoustic signal processing tasks or the like.

In one embodiment, an apparatus 700 configures means 702 with encryption modules using AES-256 for secure reception of sensitive training data from remote repositories. In some embodiments, means 704 may embed expert systems with fuzzy logic to refine selections based on preliminary data statistics. In certain embodiments, such configurations may support hybrid cloud-on-premise setups for data privacy compliance or the like.

In one embodiment, an apparatus 700 equips means 706 with adaptive learning rate schedulers decaying exponentially from 0.1 to 10\hat{ }{−5} over 7000 iterations. In some embodiments, means 708 may accelerate with preconditioned conjugate gradient solvers converging in O(sqrt(κ)) steps for condition number κ. In certain embodiments, these enhancements may apply to seismic data inversion requiring rapid kernel generations or the like.

In one embodiment, an apparatus 700 integrates means 710 with API endpoints for model serving via RESTful services on ports 8080. In some embodiments, means 712 may leverage containerization with Docker Swarm for orchestrating parallel tasks across heterogeneous nodes. In certain embodiments, such integrations may facilitate scalable deployments in IoT networks processing sensor fusion data or the like.

In one embodiment, an apparatus 700 implements means 714 with memoization caches storing intermediate recurrence terms to avoid recomputations. In some embodiments, means 702 may filter incoming data with validation schemas ensuring label consistency.

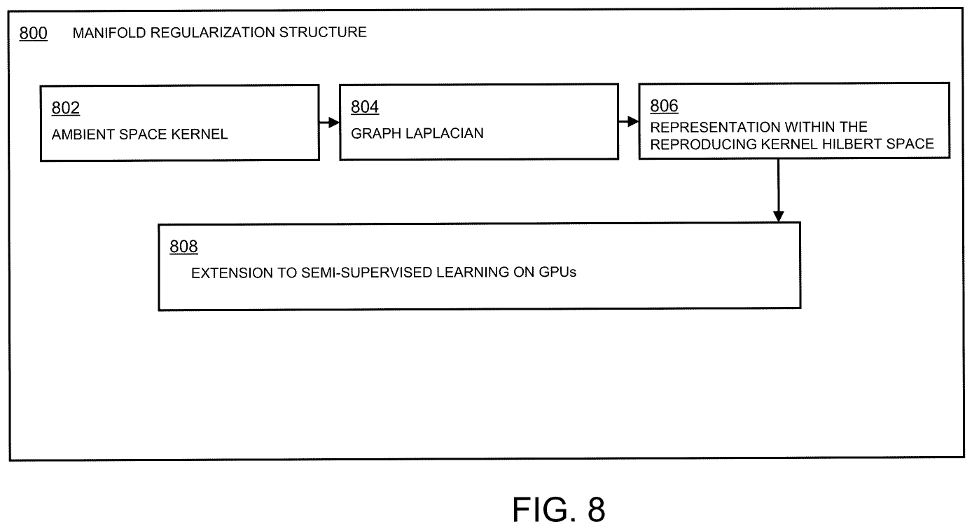

FIG. 8 depicts one embodiment of a manifold regularization structure 800 for geometric regularization in machine learning. In one embodiment, a manifold regularization structure 800 may encapsulate a framework where data is assumed to reside on a low-dimensional submanifold embedded in a higher-dimensional ambient space, guiding regularization to preserve intrinsic geometric properties during learning. In some embodiments, a manifold regularization structure 800 may generalize Laplacian-based methods by incorporating data-dependent deformations, enabling the system to adapt kernels to underlying manifold topologies without explicit manifold parameterization. In certain embodiments, implementations of a manifold regularization structure 800 may leverage spectral graph theory to approximate differential operators on discrete data graphs, e.g., in social network analyses where nodes represent users and edges capture interactions for community detection tasks or the like.

In one embodiment, a manifold regularization structure 800 includes deformation of an ambient space kernel 802, defined as the modification of a base kernel τ(x, y) through a data-driven operator to yield a deformed kernel κ(x, y) reflecting manifold distances. In some embodiments, deformation of an ambient space kernel 802 may apply an operator such as (I+μL)\hat{ }{−1}, where L denotes a graph Laplacian and μa regularization parameter tuned between 0.01 and 10 via cross-validation, transforming Euclidean similarities into geodesic approximations. In certain embodiments, ambient space kernels 802 in deformation may start as Gaussian τ(x, y)=exp(−||x−y||\hat{ }2/(2σ\hat{ }2)) with σ selected by median heuristic, deforming to κ(x, y)=τ(x, y)−τ(x, v)\hat{ }T (I+μW)\hat{ }{−1}τ(w, y) for vectors v, w parameterizing adjustments, e.g., in image segmentation where pixel features deform to respect manifold contours in color spaces or the like.

In one embodiment, a manifold regularization structure 800 includes integration with a graph Laplacian 804, constructed as L=D−W where W is a weight matrix with entries w_{ij}=exp(−||x_i−x_j||\hat{ }2/(4t)) for nearest neighbors and D a diagonal degree matrix with d_{ii}=Σj w{ij}. In some embodiments, graph Laplacian 804 integration may normalize as L_sym=D\hat{ }{−1/2}L D\hat{ }{−1/2} for symmetric forms or random-walk L_rw=D\hat{ }{−1} L for diffusion processes, with neighborhood size k=10-50 and bandwidth t calibrated to data density. In certain embodiments, spectral decompositions of a graph Laplacian 804 may yield eigenvectors approximating manifold harmonics, e.g., in recommender systems where user-item graphs regularize embeddings to capture latent preferences or the like.

In one embodiment, a manifold regularization structure 800 includes representation within a reproducing kernel Hilbert space 806, where the deformed kernel induces an inner product <f, g>_M=<f, g>_τ+μ<f, L f>_τ approximating manifold penalties. In some embodiments, Hilbert space representation 806 may embed functions via φ(x) such that <φ(x), φ(y)>=κ(x, y), ensuring reproducing property f(x)=<f, κ(·, x)>M for evaluations. In certain embodiments, scales in representation 806 may form chains H\hat{ }r with norms ||f||{H\hat{ }r}\hat{ }2=Σλ_j\hat{ }{−r}|<f, φ_j>|\hat{ }2 for eigenvalues λ_j, supporting fractional regularizations r=1/2 for semi-norm penalties, e.g., in natural language processing where text embeddings deform on semantic manifolds or the like.

In one embodiment, a manifold regularization structure 800 demonstrates extension to semi-supervised learning on GPUs 808, leveraging unlabeled data to enhance labeled predictions through manifold smoothness assumptions. In some embodiments, semi-supervised extension to semi-supervised learning on GPUs 808 may minimize objectives J(f)=Σ_{i=1}\hat{ }l(f(x_i)−y_i)\hat{ }2+μ∫_M ||∇M f||\hat{ }2 dvol+γ||f||\hat{ }2{H}, discretized via graph Laplacians for large-scale solves. In certain embodiments, GPU 808 implementations of sparse graph Laplacians facilitate constructions at scales of 10\hat{ }6 nodes, with Krylov solvers like conjugate gradients converging in 50-200 iterations for transductive settings, e.g., in anomaly detection on sensor networks utilizing vast unlabeled streams or the like.

In one embodiment, ambient space kernel 802 deformation processes may incorporate heat kernel signatures for multi-scale manifold features, computing τ_t(x, y)=Σexp(−tλ_j)φ_j(x)φ_j(y) with truncated sums for efficiency. In some embodiments, graph Laplacian 804 integrations may adopt adaptive affinities w_{ij}=exp(−d(x_i, x_j)\hat{ }2/ε_i ε_j) with local scalings ε_i as k-th neighbor distances, improving robustness to density variations. In certain embodiments, such adaptations may apply to video frame analysis where temporal manifolds regularize motion predictions or the like.

In one embodiment, Hilbert space representations 806 may extend to vector-valued kernels for multi-task learning, defining operator-valued κ(x, y): R\hat{ }m→R\hat{ }m with matrix entries. In some embodiments, semi-supervised GPU 808 extensions may incorporate co-training views, alternating optimizations over dual manifolds for reinforced label propagations. In certain embodiments, these extensions may facilitate medical imaging classifications blending labeled scans with unlabeled volumes or the like.

In one embodiment, a manifold regularization structure 800 may support intrinsic dimension estimation via Laplacian eigenvalues, thresholding cumulative sums Σ_{j=1}\hat{ }d/λ_j for effective rank d. In some embodiments, ambient space kernel 802 deformation may use diffusion maps for explicit embeddings ψ_t(x)=[√λ_1 exp(−t λ_1) φ_1(x), . . . , √λ_d exp(−t λ_d)φ_d(x)], approximating geodesic coordinates. In certain embodiments, such techniques may enhance clustering in e-commerce user behavior graphs or the like.

In one embodiment, graph Laplacians 804 may sparsify via ε-graphs or k-NN with k=log(n) for n points, balancing connectivity and computation. In some embodiments, GPU 808 extensions may leverage Thrust for parallel reductions in propagation steps, achieving 100× speedups over CPU baselines. In certain embodiments, these optimizations may support real-time semi-supervised fraud detection in transaction networks or the like.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, or custom application specific integrated circuits (“ASIC”), or off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present invention may be embodied in other specific forms without departing from its spirit or essential characteristics. The described embodiments are to be considered in all respects only as illustrative and not restrictive. The scope of the inventio is, therefore, indicated by the appended claims rather than by the foregoing description. All changes which come within the meaning and range of equivalency of the claims are to be embraced within their scope.

What is claimed is:

1. An apparatus comprising:
a processor; and
a memory storing executable code that, when executed by the processor, causes the apparatus to:
receive training data comprising labeled data points;
select a class of self-adjoint differential operator equations;
select a set of orthogonal polynomials as a spectral basis;
iteratively optimize parameters of the differential operator equations based on the training data using a gradient-based optimizer to minimize an objective function;
solve the optimized differential operator equation using a spectral method with the selected orthogonal polynomials to generate a reproducing kernel represented by a kernel tensor; and
output a machine learning model comprising the reproducing kernel combined with support vectors derived from the training data, the model configured to infer labels for unseen data points by estimating similarity measures using the reproducing kernel.

2. The apparatus of claim 1, wherein the executable code further causes the apparatus to embed input data into a d-dimensional unit cube ranging from −1 to 1 in each dimension prior to processing.

3. The apparatus of claim 1, wherein the differential operator equations are separable partial differential operator equations factored into ordinary differential equations per dimension for independent solving.

4. The apparatus of claim 1, wherein the class of self-adjoint differential operator equations is defined by step function coefficients for derivatives of order multiple of four and continuity self-adjoint boundary conditions.

5. The apparatus of claim 1, wherein the set of orthogonal polynomials is selected from a class comprising Chebyshev polynomials, ultraspherical polynomials, and Chebyshev-type discrete Sobolev polynomials.

6. The apparatus of claim 1, wherein the orthogonal polynomials are constructed recursively using fused multiply-add operations.

7. The apparatus of claim 1, wherein the objective function is selected from cross-entropy for classification or L2 loss for regression, and the optimization computes directional derivatives of the objective function.

8. The apparatus of claim 1, wherein the kernel tensor is a rank-3 array, and the reproducing kernel is a tensor product of dimensional kernels computed as quadratic forms with data expanded in the orthogonal polynomials.

9. The apparatus of claim 1, wherein the optimization applies a gauge symmetry factor to scale parameters and maintain numerical precision within memory constraints.

10. The apparatus of claim 1, wherein the executable code further causes the apparatus to precompute a left-definite template using high-precision arithmetic on a central processing unit and load the template for use in generating the kernel tensor.

11. An apparatus comprising:
a cluster of graphics processing units (GPUs), each GPU comprising a plurality of streaming multiprocessors configured for matrix multiplication, wherein the cluster is configured to:
receive training data comprising labeled data points;
parallelize computation across the GPUs by assigning differential operator equations to separate GPUs;
construct orthogonal polynomials as a spectral basis;
iteratively optimize parameters of the differential operator equations by computing gradients of an objective function;
solve the optimized equations using a spectral method to generate a reproducing kernel tensor; and
combine outputs from the GPUs to form a machine learning model using the reproducing kernel for similarity-based label inference.

12. The apparatus of claim 11, wherein each GPU is configured to maximize occupancy by prioritizing registers for polynomial construction and limiting usage for gradient computation to less than about 10% of computations.

13. The apparatus of claim 11, wherein the cluster is further configured to apply continuity self-adjoint boundary conditions in a discrete Sobolev space to the differential operator equations.

14. The apparatus of claim 11, wherein the number of orthogonal polynomials per dimension is selected based on the warp size of the GPUs.

15. The apparatus of claim 11, wherein the GPUs are units without tensor cores, optimized for precise rather than approximate matrix operations.

16. The apparatus of claim 11, wherein the cluster further comprises memory storing precomputed polynomial templates generated in arbitrary precision for loading into the GPUs.

17. An apparatus comprising:
means for receiving training data comprising labeled data points;
means for selecting a class of self-adjoint differential operator equations and a set of orthogonal polynomials as a spectral basis;
means for iteratively optimizing parameters of the selected equations based on the training data to minimize an objective function by computing gradients;
means for solving the optimized equations using a spectral method to generate a data-dependent reproducing kernel represented as a kernel tensor; and
means for outputting a machine learning model using the reproducing kernel to estimate similarities for label inference on unseen data.

18. The apparatus of claim 17, further comprising means for parallelizing the solving means across multiple dimensions using a massively parallel processing environment.

19. The apparatus of claim 17, wherein the means for selecting the orthogonal polynomials comprises means for recursively constructing Chebyshev-type discrete Sobolev polynomials.

20. The apparatus of claim 17, further comprising means for deforming an ambient space kernel for manifold regularization as a special case of the reproducing kernel.
